(19) United States
(12) Patent Application Publication
(10) Pub. No.: US 2007/0061782 A1
(43) Pub. Date: Mar. 15, 2007

(54) Independent software integration

(75) Inventors: J. Sage Schreiner, Redmond, WA (US); Avijit Sinha, Redmond, WA (US); Jeffrey M. MacDuff, Redmond, WA (US); John Clavin, Redmond, WA (US); Surendra R. Katari, Redmond, WA (US); Thomas Nielsen, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/229,039

(22) Filed: Sep. 15, 2005

(51) Int. Cl. G06F 9/44

(52) U.S. Cl. 717/124

(57) ABSTRACT

Independent software integration is described. In an embodiment, source code of independently developed software is received for integration into a developing software build and the source code is maintained as a limited-access resource to protect proprietary information contained within the source code. The source code is tested independent of the developing software build for error-free integration into the developing software build. Binary data is generated from the source code, and the binary data is integrated into the developing software build such that the independently developed software executes as an integrated component when the software build is complete.

### BACKGROUND

Newly developed software applications, such as a new operating system, typically incorporate all types of source code from independent, third-parties. For example, source code from independent hardware vendors and manufacturers can be incorporated into a new operating system to interface with external computing-based devices, such as printing devices, display devices, audio and video equipment, and any other type of device that may be connected to a computer that includes the new operating system. The independent source code is integrated because developers of the new operating system, for example, will not have access to the specific characteristics of a particular printing device such that the developers can create the hardware driver(s) for the printing device. As such, the hardware driver(s) for the printing device are best obtained from the manufacturer of the particular device.

For a newly developed software application, such as the new operating system example, a large quantity of independent source code from many different hardware vendors and manufacturers may be received and integrated into the new operating system. Managing and integrating the large quantity of independent source code can be a time-consuming and resource intensive development task. All of the source code is tested by developers when it is submitted, verified to be reliable and secure, and binary data of the source code is generated and manually integrated into a developing software application.

In addition to the time-consuming and resource intensive development tasks to receive and integrate independent source code into a developing software application, the intellectual property and other proprietary information that may be contained within the source code is exposed to the many developers and managers that may be involved with the development of the new software application. For example, a printer manufacturer may be unwilling to provide, and thus expose, proprietary information in the source code for a printer driver, such as the manufacturer's specific color science employed for the application of a print medium onto a print media.

A source build process typically relies on an availability of the independent source code, however this means that the source code is exposed to nearly everyone that may be involved with the development of the new software application. One alternative is for an independent vendor to supply only the binary encoded data of the source code for integration into a developing software application to protect any such proprietary information because, for all practical purposes, the binary encoded data prevents detection of the proprietary information. However, the binary encoded data is not modifiable, and this is an unfavorable design practice when developing a new software application, such as the new operating system. Without having the original source code available, source code tests cannot be conducted, and other issues that need to be addressed when developing the new software application cannot be quickly fixed because the source code is not available to modify and integrate as necessary.

### SUMMARY

This summary is provided to introduce simplified concepts of independent software integration which is further described below in the Detailed Description. This summary is not intended to identify essential features of the claimed subject matter, nor is it intended for use in determining the scope of the claimed subject matter.

In an embodiment of independent software integration, source code of independently developed software is received for integration into a developing software build. For example, a hardware driver is received from a third-party hardware manufacturer, such as a printer manufacturer, for integration into a new operating system that is being developed. The source code of the independently developed software is received and maintained as a limited-access resource to protect proprietary information that may be contained within the source code.

The source code is tested in a limited-access testing area independent of the developing software build for error-free integration into the developing software build. An automated testing system performs functional tests, debugs the source code, and/or security checks the source code to verify the reliability of the independently developed software before the source code is integrated into the developing software build. The automated system then generates binary data from the source code and integrates the binary data into the developing software build such that the independently developed software executes as an integrated component when the software build is complete.

### BRIEF DESCRIPTION OF THE DRAWINGS

The same numbers are used throughout the drawings to reference like features and components.

FIG. 1 illustrates an exemplary system in which embodiments of independent software integration can be implemented.

FIG. 2 illustrates an example of a Web-based user interface in an embodiment of independent software integration.

FIG. 3 illustrates an example of a software development system in which the exemplary system shown in FIG. 1 can be included, and in which embodiments of independent software integration can be implemented.

FIG. 4 illustrates an exemplary method for independent software integration.

FIG. 5 illustrates another exemplary method for independent software integration.

FIG. 6 illustrates exemplary computing systems, devices, and components in an environment that independent software integration can be implemented.

### DETAILED DESCRIPTION

Independent software integration is described in which embodiments provide that source code of independently developed software can be automatically received, tested, and integrated into a software application that is being developed (also referred to herein as a “software build”, or a “developing software build”). Independent software integration also reduces, and in some instances eliminates, the time-consuming and resource intensive tasks involved with receiving, testing, and integrating source code of independently developed software, such as from independent hardware vendors and manufacturers. In addition, independent software integration is an objective standard by which the source code can be received and evaluated, and which helps to eliminate points of subjective decision by any one developer or manager involved with the developing software build.

In an embodiment, independent software integration can be implemented to post and maintain records of all transactions associated with receiving, testing, and integrating the independent source code. The records can be maintained in a searchable database that also functions as a component of a warranty and licensing system to include the independent source code in a developing software build. In addition, independent software integration is extensible and technology-neutral in that the features described herein can be implemented to receive independent source code for any application to be integrated into any other developing or developed software application.

While aspects of the described systems and methods for independent software integration can be implemented in any number of different computing systems, environments, television-based entertainment systems, and/or configurations, embodiments of independent software integration are described in the context of the following exemplary system architectures.

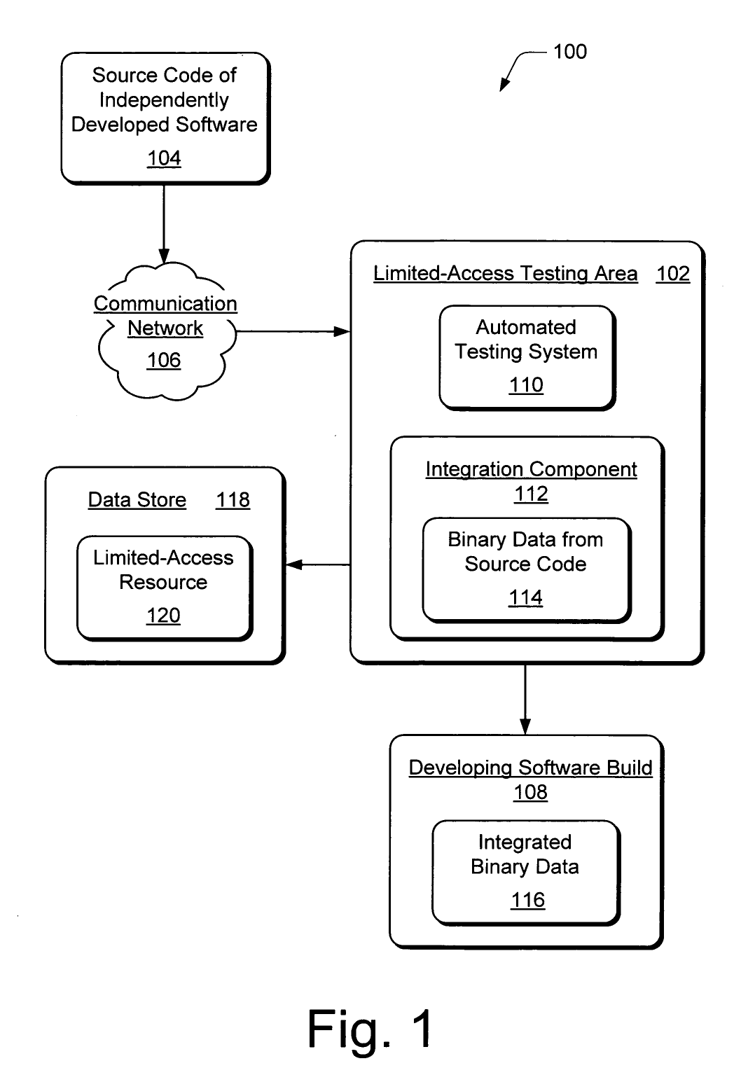

FIG. 1 illustrates an exemplary system 100 in which embodiments of independent software integration can be implemented. In this example, a limited-access testing area 102 receives source code 104 of independently developed software via a communication network 106 for integration into a developing software build 108. The source code 104 can be any type of independently developed software, such as a hardware driver for a printing device developed by a manufacturer of the printing device. The source code 104 for the device driver can be integrated into the developing software build 108, such as a new operating system that is being developed to include various hardware and/or device drivers for computing-based peripheral components such as printing devices, display devices, keyboards, pointing devices, digital audio and video equipment, and the like. In addition to device drivers, the source code 104 can be of any one or combination of a software plug-in, module, applet, process, component, and/or any other type of computing-based source code.

The limited-access testing area 102 receives the source code 104 via the communication network 106 which can be implemented as any one or more of a permissioned network, a public network, a wide area network (e.g., the Internet), and/or an intranet. Additionally, the communication network 106 can be implemented using any type of network topology or communication protocol, and can be represented or otherwise implemented as a combination of any two or more networks. The limited-access testing area 102 is a secure area that includes an automated testing system 110 and an integration component 112 to test and process the source code 104 independent of the developing software build 108. This secure area provides that intellectual property and/or other proprietary information that may be contained within the source code 104 is protected from access by just anyone working to develop the software build 108.

The automated testing system 110 in the limited-access testing area 102 tests the source code 104 of the independently developed software when it is received. The software tests can include any one or combination of tests initiated such that the source code 104 can then be integrated error-free into the developing software build 108. Such tests may include functional testing the source code, debugging the source code, and security checking the source code to verify the reliability of the independently developed software.

After the source code 104 is tested, the integration component 112 generates binary data 114 from the source code 104 and then integrates the binary data into the developing software build 108 as the integrated binary data 116. The independently developed software (i.e., binary data 116) then executes as an integrated component of the developing software build 108 when the software build is complete. For example, if the software build is a new operating system, the operating system can be shipped to include a hardware driver from an independent printer manufacturer in an event that a user of the operating system chooses to also utilize a printer from the independent printer manufacturer.

Although the automated testing system 110 and the integration component 112 are each illustrated and described as a single application configured to implement embodiments of independent software integration, the automated testing system 110 and the integration component 112 can each be implemented as several component applications distributed to each perform one or more functions in the limited-access testing area 102. Further, the automated testing system 110 may include the integration component 112 as an integrated module or component to implement embodiments of independent software integration.

The exemplary system 100 also includes a data store 118 to maintain the source code 104 of the independently developed software as a limited-access resource 120 to provide access to the source code as needed for the developing software build 108, and to further protect any proprietary information contained within the source code 104. The original source code 104 is then available on a limited-access basis and can be further utilized when developing the software build 108, such as to update or fix the developing software build 108.

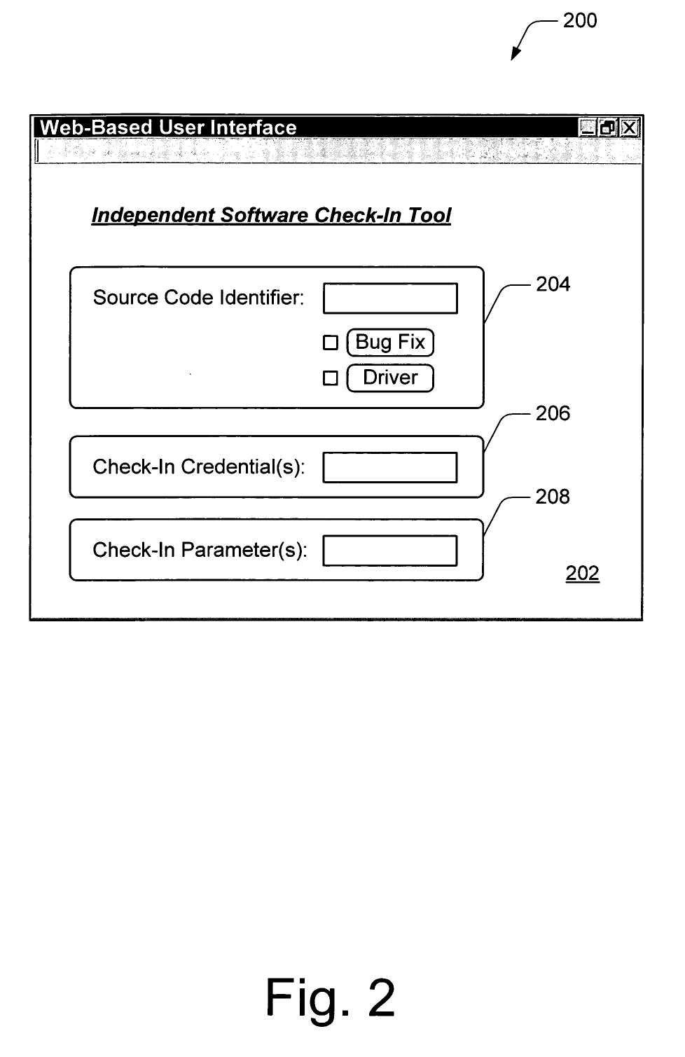

FIG. 2 illustrates an example of a Web-based user interface 200 via which source code for independently developed software can be checked-in for inclusion into a developing software build. Although described and illustrated as a Web-based user interface, independently developed software can be checked-in for inclusion into a developing software build via any type of command line user interface or application that provides a source code check-in interface. In this example, the Web-based user interface 200 includes a display 202 of various source code check-in requirements that may be requested of an independent developer that checks-in the source code 104. In this example, the display 202 includes a source code identifier 204, check-in credential(s) 206, and any number of various check-in parameter(s) 208. These credential(s) 206 and parameter(s) 208 are merely exemplary, and any combination of various source code check-in requirements may be entered via the Web-based user interface 200 to check-in source code 104 of independently developed software.

The source code identifier 204 can identify the independently developed software as a bug fix or a driver component, for example. The check-in credential(s) 206 may include verifying and/or user credentials that correspond to the independently developed software, and the credentials can be used as a basis to compare the various inputs received via the Web-based user interface 200. The various check-in parameter(s) 208 may include parameters and/or questions pertaining to functional and/or operational testing of the source code, hardware testing requirements, which developing software build the source code is intended to be integrated into, and the like. In addition, flags or warnings can be displayed for source code check-ins that do not conform to established check-in standards, such as a large source code file (e.g., greater than five megabytes), check-ins with a large number of unique drivers submitted, and/or check-ins with multiple files submitted.

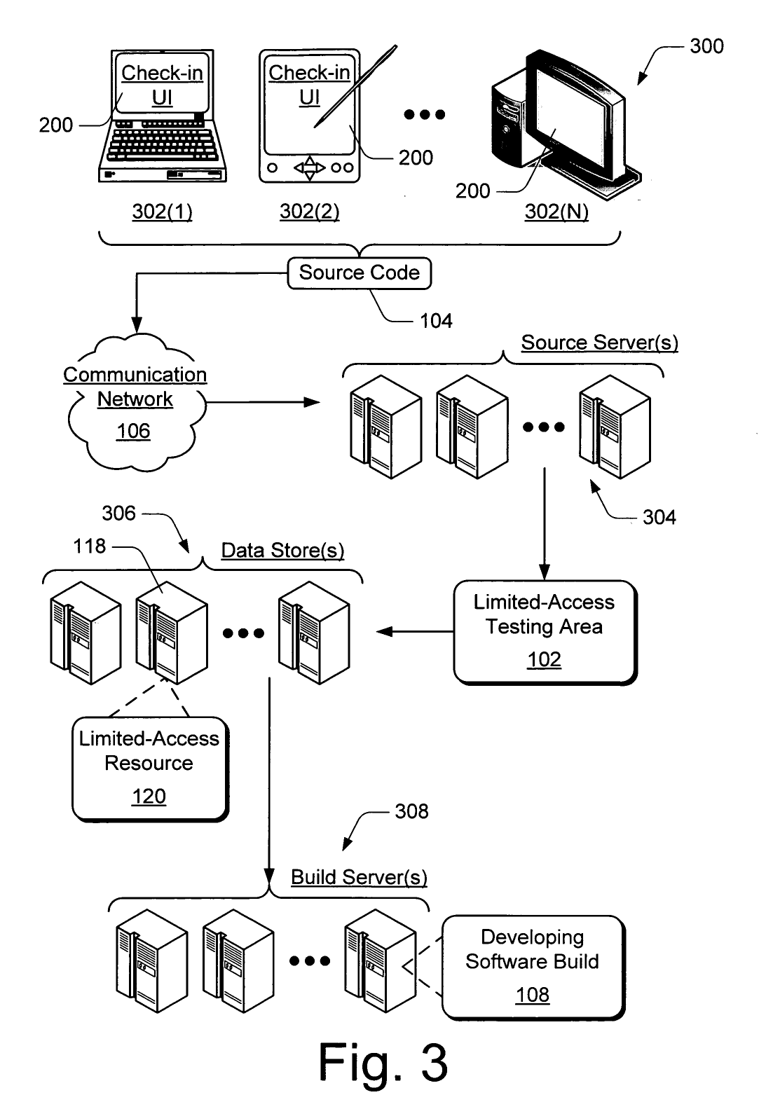

FIG. 3 illustrates an example of a software development system 300 in which the exemplary system 100 shown in FIG. 1 can be included, and in which embodiments of independent software integration can be implemented. The software development system 300 includes any number of computing-based devices 302(1-N) that may be utilized by an independent software developer to check-in independently developed software via the Web-based user interface 200 (FIG. 2). In this example, the source code 104 of the independently developed software can be submitted via a portable computing device 302(1), a mobile communication device 302(2), such as a PDA (personal digital assistant), a desktop computer 302(N), and/or via any other computing-based communication device.

The source code 104 is communicated from any of the computing-based devices 302(1-N) via a communication network 106 (described above with reference to FIG. 1) to any one or more source server(s) 304. The source server(s) 304 are a network shared repository and represent a limited-access area where the source code 104 is maintained to protect any confidential and/or proprietary information associated with or contained within the source code. In an embodiment, only those given authorization and associated with the developing software build 108 can access the source code from a source server 304.

The automated testing system 110 (FIG. 1) in the limited-access testing area 102 can then access the source code 104 from a source server 304 to test the source code with software compilers and code verification tools that mimic those utilized to develop the software build 108 such that the source code will integrate without error into the developing software build 108. Additionally, the integration component 112 (FIG. 1) can generate the binary data 114 from the source code.

The source code 104 is then maintained in any one or more data store(s) 306, such as data store 118 (FIG. 1), which maintains the source code 104 as a limited-access resource 120 to protect the proprietary information. The one or more data store(s) 306 are also an isolation layer to maintain the final version of the source code used for integration into the developing software build 108. Additionally, the binary data 114 generated from the source code is communicated to any one or more build server(s) 308 that implement a build process, or processes, to integrate the binary data 114 generated from the source code into the developing software build 108.

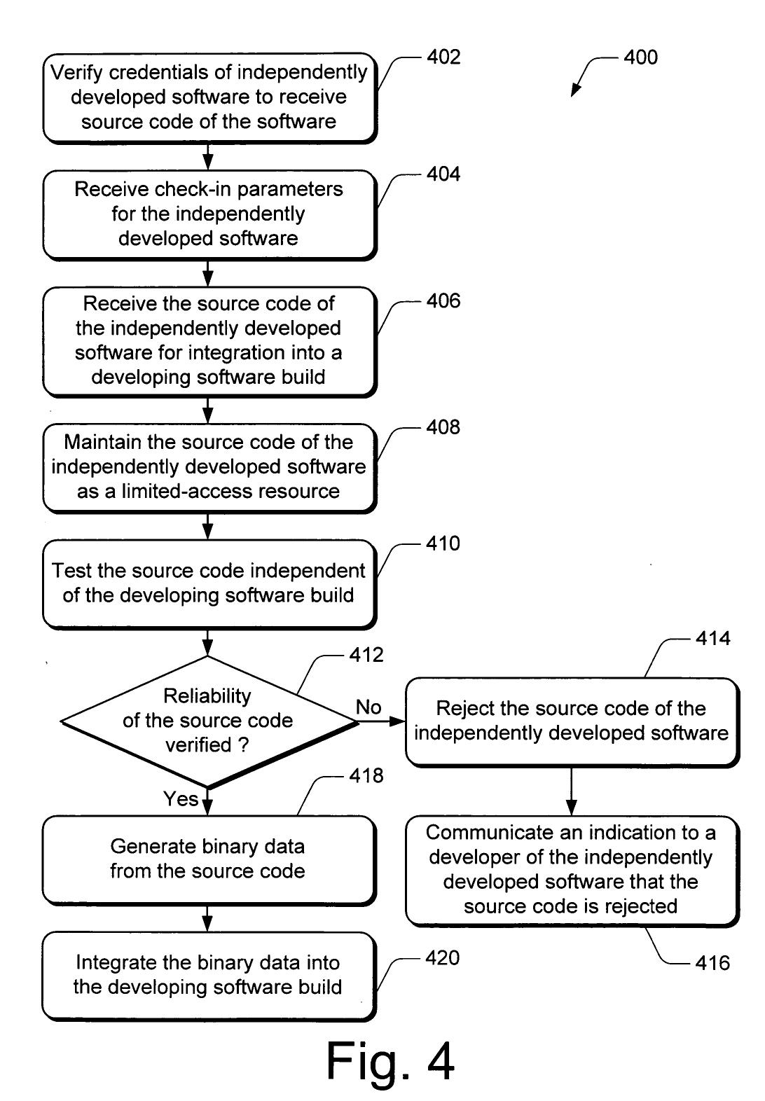

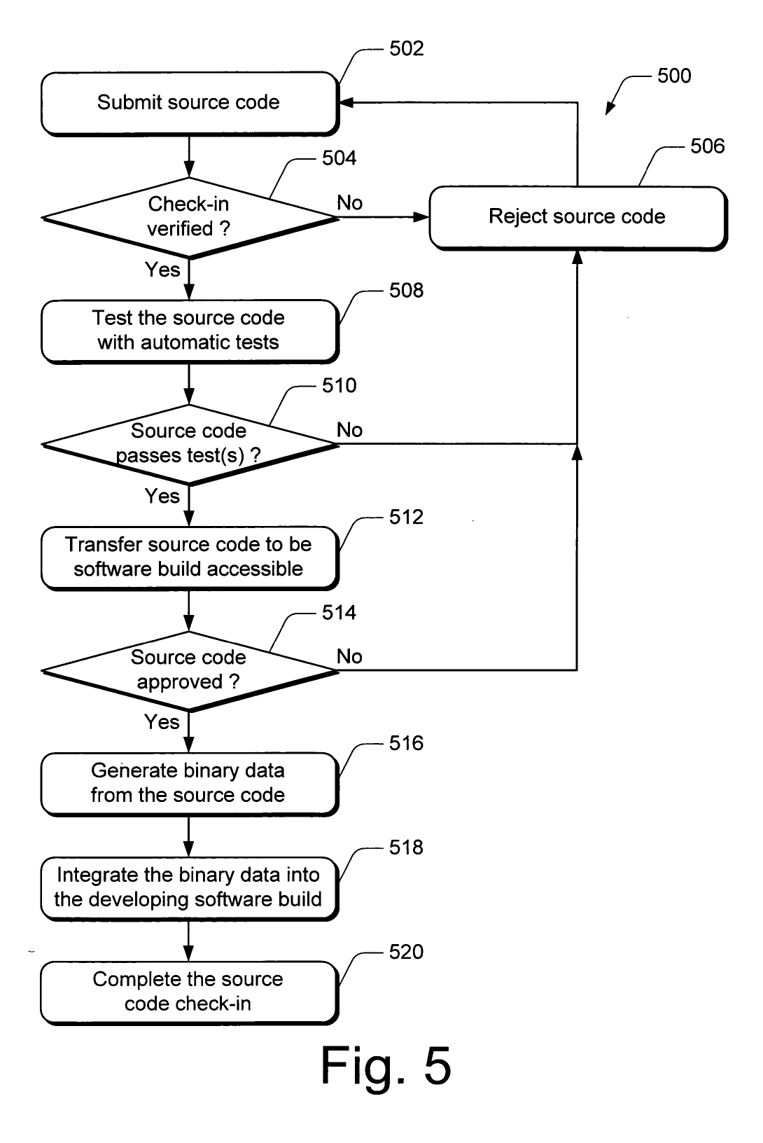

Methods for independent software integration, such as exemplary methods 400 and 500 described with reference to respective FIGS. 4 and 5, may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 4 illustrates an exemplary method 400 for independent software integration, and is described with reference to exemplary system 100 shown in FIG. 1, the Web-based user interface 200 shown in FIG. 2, and the system shown in FIG. 3. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 402, credentials corresponding to independently developed software are verified to receive source code of the independently developed software. For example, an independent developer can enter check-in credential(s) 206 on Web-based user interface 200 to submit the source code 104 of the independently developed software. At block 404, check-in parameters corresponding to the independently developed software are received. For example, the independent developer can also enter check-in parameter(s) 208 on the Web-based user interface 200 to submit the source code 104. In an embodiment, the Web-based user interface 200 is accessed via a permissioned network to check-in and submit the source code 104.

At block 406, the source code of the independently developed software is received for integration into a developing software build. For example, the source code 104 can be received from a local or remotely-located developer at a computing-based device 302(1-N) (FIG. 3), and the source code 104 is received as a limited-access resource to protect proprietary information of the independently developed software. At block 408, the source code of the independently developed software is maintained as a limited-access resource. For example, the source code 104 is maintained in a data store 118 as limited-access resource 120 to protect any confidential and/or proprietary information associated with or contained within the source code, yet to provide access to the source code as needed for the developing software build 108.

At block 410, the source code is tested independent of the developing software build. For example, the source code 104 is tested with the automated testing system 110 in the limited-access testing area 102 for error-free integration into the developing software build 108. In an embodiment, the limited-access testing area 102 is a location remote to the developing software build 108. The testing can include parsing and testing the source code, debugging the source code, parsing or verifying associated data, such as test logs, and security checking the source code to verify the reliability of the independently developed software.

At block 412, a decision is made as to whether reliability of the source code is verified. If reliability of the source code is not verified (i.e., no from block 412), then the source code of the independently developed software is rejected at block 414. At block 416, an indication is communicated to a developer of the independently developed software that the source code is rejected. If reliability of the source code is verified (i.e., yes from block 412), then binary data is generated from the source code at block 418. At block 420, the binary data is integrated into the developing software build. For example, the integration component 112 in the limited-access testing area 102 generates the binary data 114 from the source code 104. The binary data is then integrated into the developing software build 108 as the integrated binary data 116 such that the independently developed software will execute as an integrated component of the developing software build 108 when the software build is complete.

FIG. 5 illustrates an exemplary method 500 for independent software integration, and is described with reference to exemplary system 300 shown in FIG. 3. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 502, an independent software developer, such as an independent hardware vendor, submits source code to be included in a developing software build. For example, a developer can submit source code 104 from a computing-based device 302(1-N) via communication network 106. The source code can be software that is a hardware and/or device driver, a bug fix for existing software, or any other software plug-in, module, applet, process, component, and/or computing-based source code.

At block 504, a decision is made as to whether the source code check-in is verified. For example, various automated and optional user-based decisions can be made to verify the check-in, such as automatic functional test log file verification, code review, a check that the legal requirements have been met to enable acceptance of the source code, and any other type of automated or user-based decision. If the source code check-in is not verified (i.e., “no” from block 504), then the source code is rejected and returned to the independent software developer at block 506.

If the source code check-in is verified (i.e., “yes” from block 504), then the source code is tested with automatic tests at block 508. For example, the source code 104 is tested with the automated testing system 110 in the limited-access testing area 102 for error-free integration into the developing software build 108. The automatic tests can include any type of functional testing, debugging the source code, and security checking the source code to verify the reliability of the independently developed software. Examples of automatic tests include PREfast, a log parse tool, ChkInf, automatic buddy build, and the like.

At block 510, a decision is made as to whether the source code passes the automatic tests (at block 508). If the source code does not pass the automatic tests (i.e., “no” from block 510), then the source code is rejected and returned to the independent software developer at block 506. If the source code does pass the automatic tests (i.e., “yes” from block 510), then the source code is transferred to a data store accessible to the developing software build at block 512. For example, the source code 104 is maintained in any one or more data store(s) 306, such as data store 118 (FIG. 1), which maintains the source code 104 as a limited-access resource 120 to protect proprietary information that may be contained within the source code.

At block 514, a decision is made as to whether the source code is approved, or accepted for use in the developing software build. If the source code is not approved (i.e., “no” from block 514), then the source code is rejected and returned to the independent software developer at block 506. If the source code is approved (i.e., “yes” from block 514), then binary data is generated from the source code at block 516. At block 518, the binary data is integrated into the developing software build, and at block 520, the source code check-in is completed.

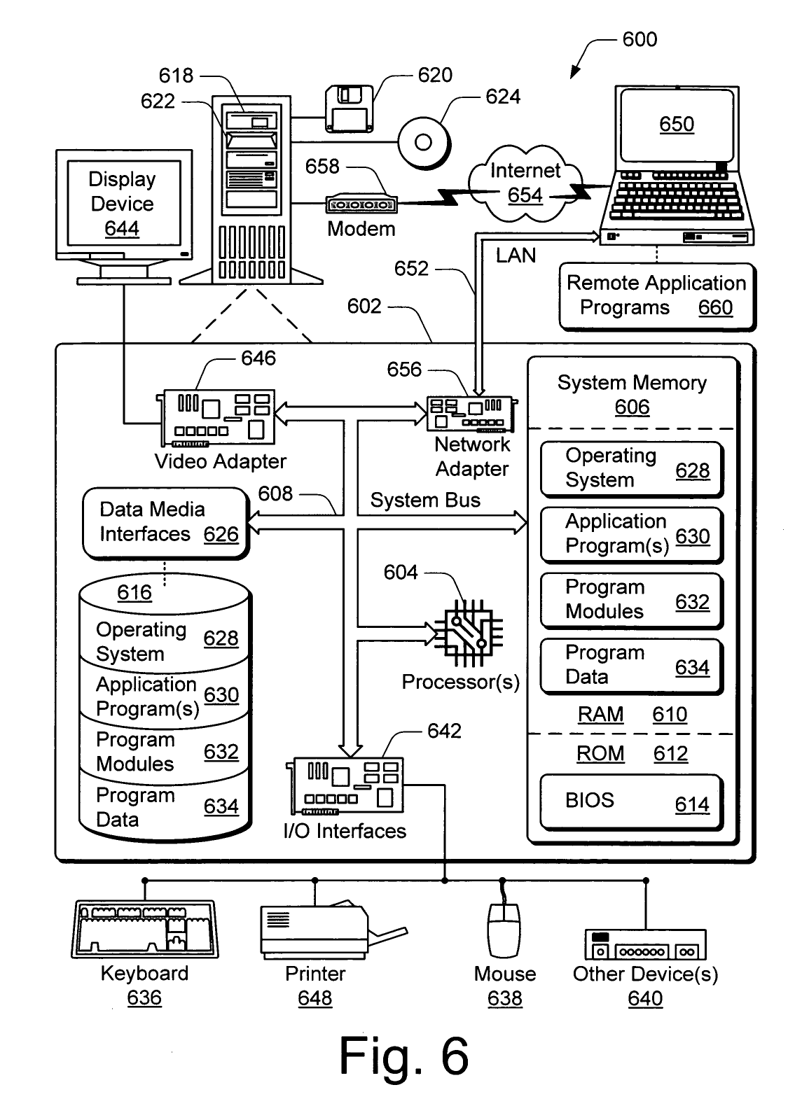

FIG. 6 illustrates an exemplary computing environment 600 within which independent software integration systems and methods, as well as the computing, network, and system architectures described herein, can be either fully or partially implemented. Exemplary computing environment 600 is only one example of a computing system and is not intended to suggest any limitation as to the scope of use or functionality of the architectures. Neither should the computing environment 600 be interpreted as having any dependency or requirement relating to any one or combination of components illustrated in the exemplary computing environment 600.

The computer and network architectures in computing environment 600 can be implemented with numerous other general purpose or special purpose computing system environments or configurations. Examples of well known computing systems, environments, and/or configurations that may be suitable for use include, but are not limited to, personal computers, server computers, client devices, hand-held or laptop devices, microprocessor-based systems, multiprocessor systems, set top boxes, programmable consumer electronics, network PCs, minicomputers, mainframe computers, gaming consoles, distributed computing environments that include any of the above systems or devices, and the like.

The computing environment 600 includes a general-purpose computing system in the form of a computing device 602. The components of computing device 602 can include, but are not limited to, one or more processors 604 (e.g., any of microprocessors, controllers, and the like), a system memory 606, and a system bus 608 that couples the various system components. The one or more processors 604 process various computer executable instructions to control the operation of computing device 602 and to communicate with other electronic and computing devices. The system bus 608 represents any number of several types of bus structures, including a memory bus or memory controller, a peripheral bus, an accelerated graphics port, and a processor or local bus using any of a variety of bus architectures.

Computing environment 600 includes a variety of computer readable media which can be any media that is accessible by computing device 602 and includes both volatile and non-volatile media, removable and non-removable media. The system memory 606 includes computer readable media in the form of volatile memory, such as random access memory (RAM) 610, and/or non-volatile memory, such as read only memory (ROM) 612. A basic input/output system (BIOS) 614 maintains the basic routines that facilitate information transfer between components within computing device 602, such as during start-up, and is stored in ROM 612. RAM 610 typically contains data and/or program modules that are immediately accessible to and/or presently operated on by one or more of the processors 604.

Computing device 602 may include other removable/non-removable, volatile/non-volatile computer storage media. By way of example, a hard disk drive 616 reads from and writes to a non-removable, non-volatile magnetic media (not shown), a magnetic disk drive 618 reads from and writes to a removable, non-volatile magnetic disk 620 (e.g., a “floppy disk”), and an optical disk drive 622 reads from and/or writes to a removable, non-volatile optical disk 624 such as a CD-ROM, digital versatile disk (DVD), or any other type of optical media. In this example, the hard disk drive 616, magnetic disk drive 618, and optical disk drive 622 are each connected to the system bus 608 by one or more data media interfaces 626. The disk drives and associated computer readable media provide non-volatile storage of computer readable instructions, data structures, program modules, and other data for computing device 602.

Any number of program modules can be stored on RAM 610, ROM 612, hard disk 616, magnetic disk 620, and/or optical disk 624, including by way of example, an operating system 628, one or more application programs 630, other program modules 632, and program data 634. Each of such operating system 628, application program(s) 630, other program modules 632, program data 634, or any combination thereof, may include one or more embodiments of the systems and methods described herein.

Computing device 602 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example and not limitation, communication media includes wired media such as a wired network or direct-wired connection, and wireless media such as acoustic, RF, infrared, other wireless media, and/or any combination thereof.

A user can interface with computing device 602 via any number of different input devices such as a keyboard 636 and pointing device 638 (e.g., a “mouse”). Other input devices 640 (not shown specifically) may include a microphone, joystick, game pad, controller, satellite dish, serial port, scanner, and/or the like. These and other input devices are connected to the processors 604 via input/output interfaces 642 that are coupled to the system bus 608, but may be connected by other interface and bus structures, such as a parallel port, game port, and/or a universal serial bus (USB).

A display device 644 (or other type of monitor) can be connected to the system bus 608 via an interface, such as a video adapter 646. In addition to the display device 644, other output peripheral devices can include components such as speakers (not shown) and a printer 648 which can be connected to computing device 602 via the input/output interfaces 642.

Computing device 602 can operate in a networked environment using logical connections to one or more remote computers, such as remote computing device 650. By way of example, remote computing device 650 can be a personal computer, portable computer, a server, a router, a network computer, a peer device or other common network node, and the like. The remote computing device 650 is illustrated as a portable computer that can include any number and combination of the different components, elements, and features described herein relative to computing device 602.

Logical connections between computing device 602 and the remote computing device 650 are depicted as a local area network (LAN) 652 and a general wide area network (WAN) 654. Such networking environments are commonplace in offices, enterprise-wide computer networks, intranets, and the Internet. When implemented in a LAN networking environment, the computing device 602 is connected to a local network 652 via a network interface or adapter 656. When implemented in a WAN networking environment, the computing device 602 typically includes a modem 658 or other means for establishing communications over the wide area network 654. The modem 658 can be internal or external to computing device 602, and can be connected to the system bus 608 via the input/output interfaces 642 or other appropriate mechanisms. The illustrated network connections are merely exemplary and other means of establishing communication link(s) between the computing devices 602 and 650 can be utilized.

In a networked environment, such as that illustrated with computing environment 600, program modules depicted relative to the computing device 602, or portions thereof, may be stored in a remote memory storage device. By way of example, remote application programs 660 are maintained with a memory device of remote computing device 650. For purposes of illustration, application programs and other executable program components, such as operating system 628, are illustrated herein as discrete blocks, although it is recognized that such programs and components reside at various times in different storage components of the computing device 602, and are executed by the one or more processors 604 of the computing device 602.

Although embodiments of independent software integration have been described in language specific to structural features and/or methods, it is to be understood that the subject of the appended claims is not necessarily limited to the specific features or methods described. Rather, the specific features and methods are disclosed as exemplary implementations of independent software integration.

1. An automated computer-based method, comprising:
receiving source code of independently developed software for integration into a developing software build, the source code being received as a limited-access resource to protect proprietary information of the independently developed software;
testing the source code independent of the developing software build for error-free integration into the developing software build;
generating binary data from the source code; and
integrating the binary data into the developing software build such that the independently developed software is configured to execute as an integrated component of the developing software build when the software build is complete.

2. An automated computer-based method as recited in claim 1, further comprising maintaining the source code of the independently developed software as the limited-access resource to provide access to the source code as needed for the developing software build.

3. An automated computer-based method as recited in claim 1, wherein the developing software build is an operating system, and wherein the independently developed software is a hardware driver received for integration into the operating system.

4. An automated computer-based method as recited in claim 1, further comprising verifying credentials corresponding to the independently developed software to receive the source code.

5. An automated computer-based method as recited in claim 1, wherein receiving the source code includes receiving the source code from a remotely-located developer, and wherein testing the source code includes testing the source code at a location remote to the developing software build.

6. An automated computer-based method as recited in claim 1, wherein receiving the source code includes receiving check-in parameters corresponding to the independently developed software entered on a user interface accessed via a permissioned network.

7. An automated computer-based method as recited in claim 1, wherein testing the source code includes parsing and testing the source code, debugging the source code, log file verification, and security checking the source code to verify the reliability of the independently developed software.

8. An automated computer-based method as recited in claim 1, further comprising rejecting the source code of the independently developed software in an event that reliability of the source code is not verified when said testing the source code, and communicating an indication to a developer of the independently developed software that the source code is rejected.

9. An independent software integration system, comprising:
a user interface via which check-in parameters corresponding to independently developed software are entered to submit source code of the independently developed software for integration into a developing software build;
a limited-access testing area configured to maintain the source code to protect proprietary information of the independently developed software;
an automated testing system configured to test the source code independent of the developing software build for error-free integration into the developing software build; and
an integration component of the automated testing system configured to generate binary data from the source code and integrate the binary data into the developing software build such that the independently developed software is configured to execute as an integrated component of the developing software build when the software build is complete.

10. An independent software integration system as recited in claim 9, a data store configured to maintain the source code of the independently developed software as a limited-access resource to provide access to the source code as needed for the developing software build.

11. An independent software integration system as recited in claim 9, wherein the developing software build is an operating system, and wherein the independently developed software is a hardware driver configured for integration into the operating system.

12. An independent software integration system as recited in claim 9, wherein the user interface is configured to verify credentials corresponding to the independently developed software to receive the check-in parameters and the source code.

13. An independent software integration system as recited in claim 9, wherein the user interface is accessed via a permissioned network via which a remotely-located developer enters the check-in parameters and submits the source code.

14. An independent software integration system as recited in claim 9, wherein the automated testing system is further configured to parse and test the source code, debug the source code, and security check the source code to verify the reliability of the independently developed software before the binary data is generated and integrated into the developing software build.

15. An independent software integration system as recited in claim 9, wherein the automated testing system is further configured to reject the source code of the independently developed software in an event that reliability of the source code is not verified when the source code is tested.

16. One or more computer readable media comprising computer executable instructions that, when executed, direct an automated computer-based system to:
receive source code for integration into a developing software build;
test the source code independent of the developing software build in a limited-access testing area to protect proprietary information contained within the source code;
maintain the source code as a limited-access resource to further protect the proprietary information contained within the source code;
generate binary data from the source code; and
integrate the binary data into the developing software build such that the binary data executes integral to the developing software build when the software build is complete.

17. One or more computer readable media as recited in claim 16, further comprising computer executable instructions that, when executed, direct the automated computer-based system to verify credentials when the source code is submitted to receive the source code.

18. One or more computer readable media as recited in claim 16, further comprising computer executable instructions that, when executed, direct the automated computer-based system to receive check-in parameters corresponding to the source code entered on a user interface of an independent software integration system accessed via a permissioned network.

19. One or more computer readable media as recited in claim 16, further comprising computer executable instructions that, when executed, direct the automated computer-based system to parse and test the source code, debug the source code, and security check the source code to verify the reliability of the source code for error-free integration into the developing software build.

20. One or more computer readable media as recited in claim 16, further comprising computer executable instructions that, when executed, direct the automated computer-based system to reject the source code in an event that reliability of the source code is not verified when the source code is tested.
